(19) United States
(12) Patent Application Publication
(10) Pub. No.: US 2015/0272090 A1
(43) Pub. Date: Oct. 1, 2015

(54) IN-TANK FILTER MEDIA REACTOR

(71) Applicant: Kimberly Schaumburg, Vaughan, WA (US)

(72) Inventor: Kimberly Schaumburg, Vaughan, WA (US)

(21) Appl. No.: 14/668,573

(22) Filed: Mar. 25, 2015

Related U.S. Application Data
(60) Provisional application No. 61/970,262, filed on Mar. 25, 2014.

(51) Int. Cl. A01K 63/04; C02F 1/28; C02F 3/34; C02F 3/30

(52) U.S. Cl. CPC A01K 63/045; C02F 3/308; C02F 1/283; C02F 3/348; C02F 2101/105

(57) ABSTRACT

An in-tank filter media reactor includes a base coupled to a filter media container. A top funnel component is coupled to the top of the filter media container. A bottom mesh filter element attached to the center area of the media container. The base includes an opening sized to allow fluid flow through the base and up through the filter media container and eventually through the top funnel component when driven by a flow generated from a flow generator so as to produce a Venturi effect.

### CROSS-REFERENCE TO RELATED APPLICATIONS

This application is a non-provisional application of and claims priority from co-pending U.S. Provisional Patent Application No. 61/970,262, filed Mar. 25, 2014 to Schaumburg and entitled “FILTER MEDIA CAGE,” the entire contents of which is incorporated by reference.

### TECHNICAL FIELD

The present invention relates to a filter apparatus for aquariums and, more particularly, to an unpowered standalone in-tank filter media reactor for fresh water and salt water aquariums.

### BACKGROUND

Aquariums, especially salt water aquariums, represent a substantial investment for their owners in equipment, plant life, fish and accessories. Thus they require constant maintenance including the use of filtration systems in order to maintain a healthy aquatic environment. Presently available filtration systems are expensive and difficult to maintain. They usually require complicated pump systems, a sump, and multiple compartments some of which tend to become saturated with contaminants rendering them unsuitable for use, even to the point of causing them to add contaminants to the system. Existing filter media devices, called media reactors, require time consuming procedures to exchange exhausted filter media, tend to tumble the media too vigorously, which can degrade (break up) certain filter media and/or result in less efficient filtering as some media require gentle tumbling for maximum efficiency, and have the potential to malfunction in a manner that, because they are located outside the aquarium, could result in significant water damage to one's residence or the loss of tank occupants.

For example, in U.S. Pat. No. 8,262,907, having issue date Sep. 11, 2012 entitled “Composite sock filter for aquariums,” to Hudson et al. vertical sock filters for aquarium filter assemblies are disclosed. The sock filters typically include an annular collar coupled to filter material. The disclosed sock filters are not standalone devices but rather are configured for use in aquarium filter assemblies including attachment to a pump for pumping water from the aquarium tank directly into the sock filter such that the flow proceeds lengthwise through the sock filter from top to bottom.

As another example, in U.S. Pat. No. 5,306,421, having issue date Apr. 26, 1994 and entitled “Filtration system for a fish tank,” to Weinstein an internally-situated filter assembly for an aquarium tank is disclosed. The assembly includes a pump that returns filtered water collected in the catch basin to the aquarium compartment.

U.S. Pat. No. 4,622,148, having issue date Nov. 11, 1986 entitled “Aquarium filter system,” to Allan H. Willinger includes a filter assembly for use in filtering and treating contaminated water in an aquarium tank. A filter bag is used for receiving a continuous supply of contaminated water under a predetermined pressure supplied by a pump to which the filter bag is attached.

In U.S. Pat. No. 4,186,093, having issue date Jan. 29, 1980, to Allan H. Willinger and entitled “Bottom aquarium filter,” a bottom aquarium filter for an aquarium tank is disclosed. That filter includes a container having an inlet compartment which can receive contaminated water from the tank, and a filtration compartment which converts the contaminated water into decontaminated water. An air diffuser, attached by tubing to an air compressor located outside the aquarium tank, provides a stream of air bubbles to lift water from the decontaminated water compartment through an air lift tube. The water then leaves together with the air through an outlet in the air lift tube and back into the tank.

As shown in the examples above, known filter systems require complex assemblies of expensive containers, screens, specialized pumps and filtering elements. In some cases, because of their complicated construction, filtering media cannot be easily exchanged (depending on the brand). Buildup of nitrates or phosphates is a common problem with “hang on the back” (HOB) filters or canister filters.

The present invention provides a solution for these drawbacks by providing a device that provides the simplicity of in-tank usage (working in the tank or sump), thus not requiring a powerful pump to draw water through it and back to the aquarium, thus using less electricity and eliminating the possibility of messy and/or costly leakage outside the aquarium. In one aspect, the in-tank filter media reactor of the present invention operates with standard, detached, power heads. It provides readily interchangeable filter media and may easily be removed or moved in a tank. As a further advantage, it may be placed in any convenient location in a tank.

### BRIEF SUMMARY OF THE DISCLOSURE

This summary is provided to introduce a selection of concepts in a simplified form that are further described below in the Detailed Description. This summary is not intended to identify key features of the claimed subject matter, nor is it intended to be used as an aid in determining the scope of the claimed subject matter.

An in-tank filter media reactor is disclosed including a base coupled to a filter media container. A top funnel component is coupled to the top of the filter media container. A bottom mesh filter element is attached to the media container. The base includes a base opening sized to allow fluid to flow through the base opening, then up through the filter media container and eventually be drawn through the top funnel component when driven by a flow generated from a flow generator so as to produce a Venturi effect.

In one aspect, the in-tank filter media reactor further includes ballast located to hold the in-tank filter media reactor in place in an aquarium.

In another aspect, the base and funnel are fabricated from plastic polymers, nylon polymers, acrylic polymers or combinations thereof.

In another aspect, the filter media container is filled with a filter media selected from the group consisting of chemical filter media, activated carbon-based media, phosphate removers, bio-pellets, and combinations thereof.

In an alternate aspect, the in-tank filter media reactor further includes a top mesh filter element located between the funnel top and the bottom mesh filter element.

In another aspect, the bottom mesh filter element comprises a mesh made from material selected from the group consisting of nylon, polymers, polyester and combinations thereof.

In a further aspect, a method for filtering an aquarium includes installing an in-tank filter media reactor including a base coupled to a filter media container, a top funnel component coupled to the top of the filter media container, a bottom mesh filter element attached to the bottom of the media container, wherein the base includes an opening sized to allow fluid to flow through the base, then up through the filter media container and eventually to be drawn through the top funnel component when driven by a flow generated from a flow generator. The filter media container is filled with a filter media selected from the group consisting of chemical filter media, activated carbon-based media, phosphate removers, bio-pellets, and combinations thereof. After the in-tank filter media reactor is secured in place in an aquarium, a fluid flow is directed into the opening and a Venturi effect is created by the funnel lid that tumbles the filter media.

Other benefits and advantages of the present invention will become apparent from the disclosure, claims and drawings herein.

### BRIEF DESCRIPTION OF THE DRAWINGS

While the novel features of the invention are set forth with particularity in the appended claims, the invention, both as to organization and content, will be better understood and appreciated, along with other objects and features thereof, from the following detailed description taken in conjunction with the drawings, in which:

FIG. 1 schematically shows a schematic view of an example of an in-tank filter media reactor.

FIG. 2 shows an exploded view of the main components of an in-tank filter media reactor.

FIG. 3 schematically shows a top view of an example of an in-tank filter media reactor screening element.

FIG. 4 schematically shows a view of an example of an in-tank filter media reactor as employed in an aquarium.

In the drawings, identical reference numbers identify similar elements or components. The sizes and relative positions of elements in the drawings are not necessarily drawn to scale. For example, the shapes of various elements and angles are not drawn to scale, and some of these elements are arbitrarily enlarged and positioned to improve drawing legibility. Further, the particular shapes of the elements as drawn, are not intended to convey any information regarding the actual shape of the particular elements, and have been solely selected for ease of recognition in the drawings.

### DETAILED DESCRIPTION OF THE PREFERRED EMBODIMENTS

The following disclosure describes several embodiments for an in-tank filter media reactor. Several features of methods and systems in accordance with example embodiments are set forth and described in the Figures. It will be appreciated that methods and systems in accordance with other example embodiments can include additional procedures or features different than those shown in the Figures. Example embodiments are described herein with respect to an in-tank filter media reactor integrated into an aquarium tank. However, it will be understood that these examples are for the purpose of illustrating the principles, and that the invention is not so limited. Additionally, methods and systems in accordance with several example embodiments may not include all of the features shown in the Figures.

Unless the context requires otherwise, throughout the specification and claims which follow, the word “comprise” and variations thereof, such as, “comprises” and “comprising” are to be construed in an open, inclusive sense that is as “including, but not limited to.”

Reference throughout this specification to “one example” or “an example embodiment,” “one embodiment,” “an embodiment” or combinations and/or variations of these terms means that a particular feature, structure or characteristic described in connection with the embodiment is included in at least one embodiment of the present disclosure. Thus, the appearances of the phrases “in one embodiment” or “in an embodiment” in various places throughout this specification are not necessarily all referring to the same embodiment. Furthermore, the particular features, structures, or characteristics may be combined in any suitable manner in one or more embodiments.

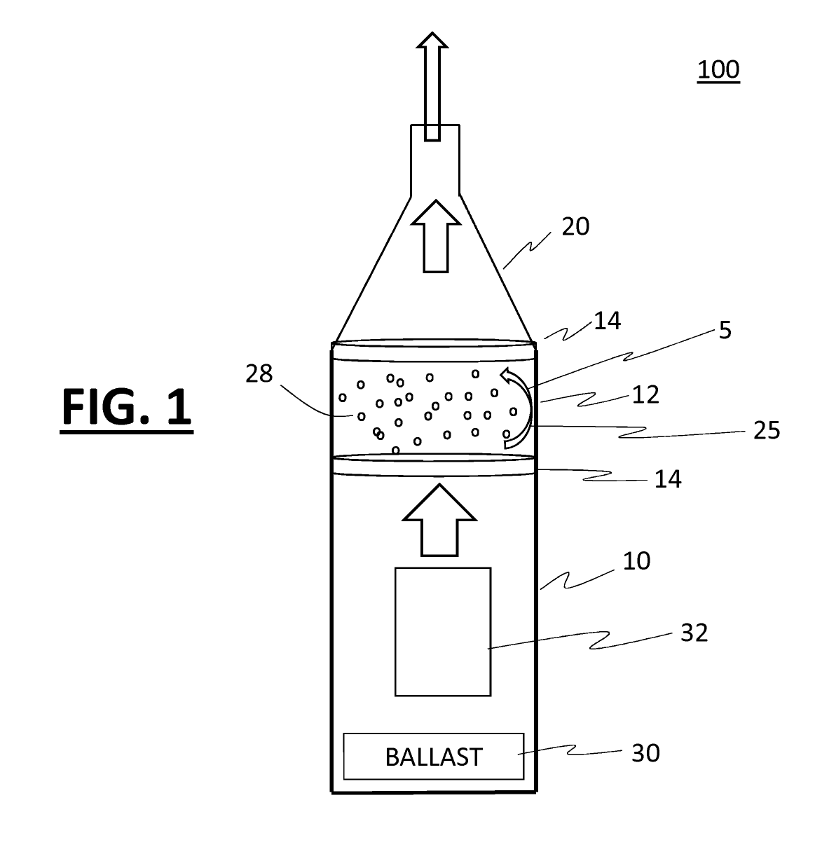

Referring now to FIG. 1, a schematic view of an example of an in-tank filter media reactor is schematically shown. An in-tank filter media reactor 100 includes a base 10 coupled to a filter media container 12 which is, in turn, coupled to a top funnel component 20. The base 10 includes an opening 32 which allows fluid to flow through the base and up through the filter media container 12 and eventually to be drawn through the top funnel component 20. The components may be fabricated from plastic polymers, nylon polymers, acrylic polymers, or the like. A bottom mesh filter element 14 is attached to the center area of the media container 12. The opening 32 is proportionately sized to accept the flow coming from an in-tank flow generator such as a power head. An optional top mesh filter element 14 may also be used.

The filter media container 12 is preferably filled with a filter media 28. The filter media container 12 may contain any filter media that can be tumbled as desired for a particular application. Chemical filter media such as, for example, activated carbon-based media, phosphate removers, bio-pellets, and the like may be used. The optional ballast material 30 may comprise any suitably inert ballast such as, for example, rock, glass or the like. In the preferred design, the in-tank filter media reactor is constructed in a vertically stacked arrangement with the top opening of the funnel being disposed closest to the surface of the water in the aquarium when installed.

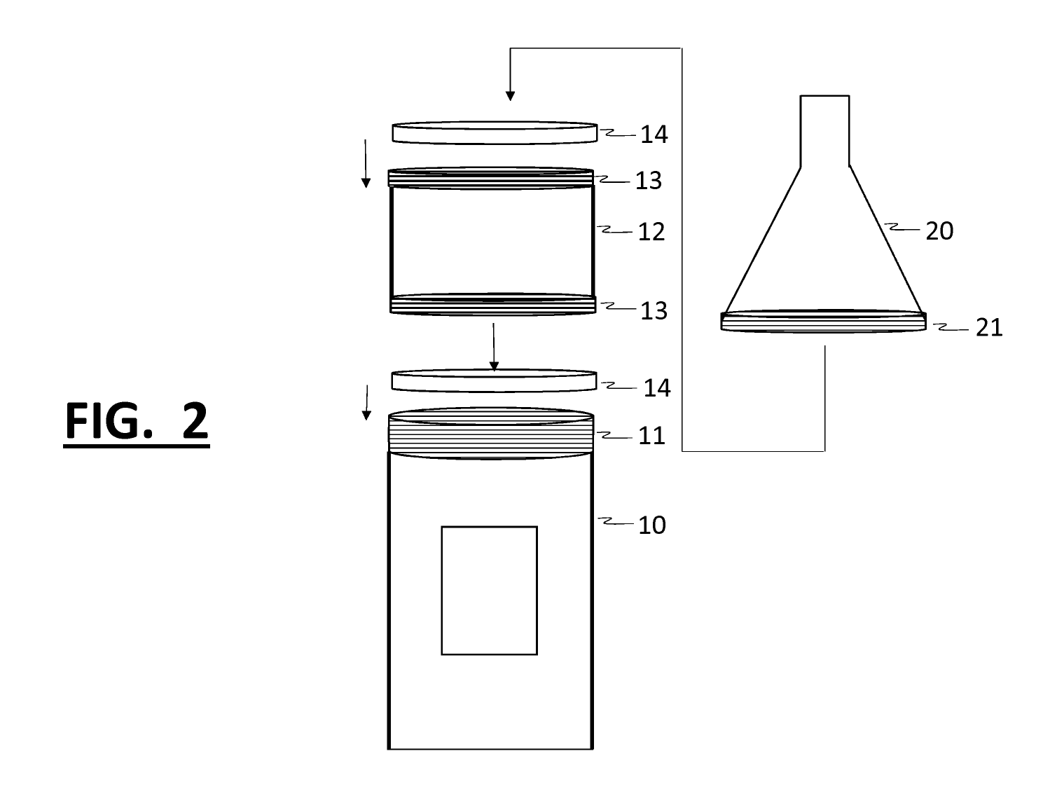

Referring now to FIG. 2, an exploded view of the main components of an in-tank filter media reactor is shown in more detail. Each of the main components of the filter media 100 may be advantageously fabricated to be assembled using conventional means such as mating screw-on portions. For example, the base 10 may include a threaded portion 11 which mates with the threaded portion 13 of the filter media container 12. In between the base 10 and the filter media 12 one of the filter mesh elements 14 can be held in place in a conventional manner such as by providing a lip or other mounting surface within the base 10. The top funnel component 20 is connected to have its narrow top opening function as the outlet that draws any fluid being pumped through while the broader opening at its base is tightly sealed to the top of the filter media container 12. Thus, the funnel 20 has a threaded base 21 suitable for screwing onto the top of the filter media container 12 to form a substantially leak-proof seal. If used, a top filter mesh element 14 is held in between the top funnel and the filter media container 12.

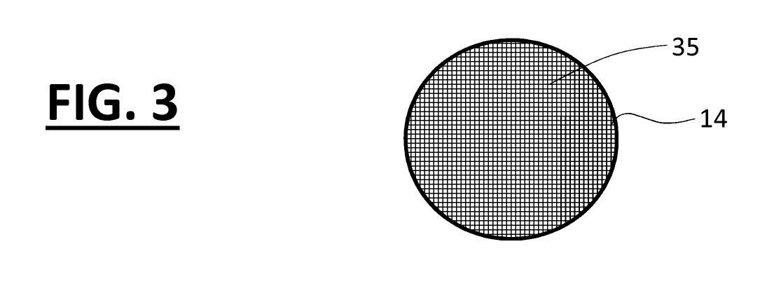

Referring now to FIG. 3, a top view of an example of an in-tank filter media reactor screening element is schematically shown. Each filter mesh element 14 may include a selected mesh 35. The selected mesh 35 is chosen from any of a variety of available mesh products made from nylon, polymers, polyester and the like. The mesh should allow good flow, while being a small enough mesh size to contain the media. In one example used for small particle filtering media the mesh may have openings of at least about 0.008 inches with a thickness of at least about 0.006 inches.

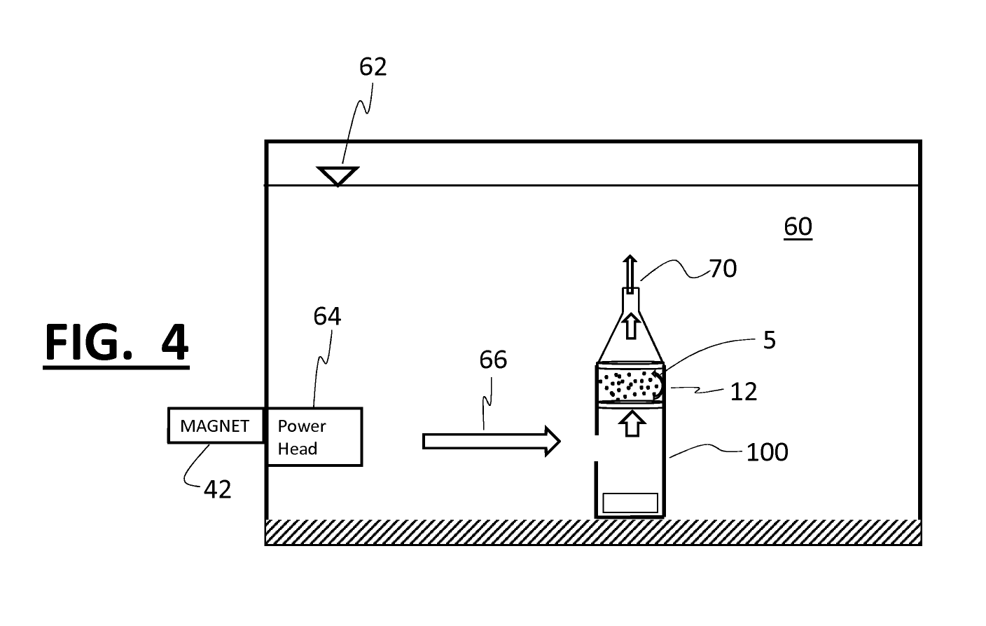

Referring now to FIG. 4, a view of an example of an in-tank filter media reactor as employed in an aquarium is a schematically shown. In one embodiment, an aquarium tank 60 includes fluid such as fresh water or salt water as indicated by fluid level marker 62. A power head 64 is mounted by means of, for example, a magnet 42, on to the aquarium tank 60 to provide a fluid flow indicated by directional arrow 66.

Having described the elements and construction of the invention it is now believed to be useful to the understanding of the invention to describe an example of its use in practice. The filter media container is filled with filter media of choice and then placed in a vertical orientation in the aquarium tank. The in-tank filter media reactor may also optionally be loaded with or attached to a sufficient amount of ballast to keep it from moving when placed in an aquarium tank or pinned in place by rocks present in the aquarium. The amount of ballast will vary depending the size of the tank and the power head flow rate, as can easily be determined from placing the filter in the tank and turning on the power head.

Once the powerhead is activated, the flow of water through the top funnel component will create a Venturi effect and cause water to flow at a faster rate through the narrow opening at the outlet 70. In effect the flow rate into the opening 32 is accelerated by the time it exits the in-tank filter media reactor. This change in flow rate causes the media 28 to tumble within the filter media container 12 as indicated by curved arrow five (as best shown in FIG. 1). Media such as, for example, activated carbon, granular ferric oxide, bio-pellets, or other filter media will tumble as water is drawn upward through the narrow funnel opening. In this way, the aquarium tank water is filtered and cleaned.

The in-tank filter media reactor disclosed herein also makes it very easy to clean and replace both the filter elements and the filter media. Since there is no attachment to the aquarium tank, the in-tank filter media reactor may simply be removed and the elements detached from each other for cleaning. Fresh filter media may then be placed into the filter media container and the in-tank filter media reactor may then be put in position within the aquarium tank. Note that if the optional top mesh filter component is not used, the user may need to cover the top opening of the funnel (e.g. as with a fingertip) when submerging the in-tank filter media reactor into the aquarium to keep any filter media from escaping.

While the components herein have been shown as generally cylindrical shapes, the invention is not so limited. Other geometric shapes may be used including rectangular, triangular, oval, hexagonal, etc. in such cases the threaded elements may be replaced with, for example, snap on or other tightfitting interfaces for joining the components.

The invention has been described herein in considerable detail in order to comply with the Patent Statutes and to provide those skilled in the art with the information needed to apply the novel principles of the present invention, and to construct and use such exemplary and specialized components as are required. However, it is to be understood that the invention may be carried out by different equipment, and devices, and that various modifications, both as to the equipment details and operating procedures, may be accomplished without departing from the true spirit and scope of the present invention.

What is claimed is:

1. An in-tank filter media reactor comprising:
a base coupled to a filter media container;
a top funnel component coupled to the top of the filter media container;
a bottom mesh filter element attached to the center area of the media container; and
wherein the base includes a base opening sized to allow fluid to flow through the base opening, then up through the filter media container and eventually be drawn through the top funnel component when driven by a flow generated from a flow generator so as to produce a Venturi effect.

2. The in-tank filter media reactor of claim 1 further comprising ballast located to hold the in-tank filter media reactor in place in an aquarium.

3. The in-tank filter media reactor of claim 1 wherein the base and funnel are fabricated from plastic polymers, nylon polymers, acrylic polymers or combinations thereof.

4. The in-tank filter media reactor of claim 1 wherein the filter media container is filled with a filter media selected from the group consisting of chemical filter media, activated carbon-based media, phosphate removers, bio-pellets, and combinations thereof.

5. The in-tank filter media reactor of claim 1 further comprising a top mesh filter element located between the funnel top and the bottom mesh filter element.

6. The in-tank filter media reactor of claim 1 wherein the bottom mesh filter element comprises a mesh made from material selected from the group consisting of nylon, polymers, polyester and combinations thereof.

7. The in-tank filter media reactor of claim 1 wherein the flow generator comprises a power head affixed to a tank wall.

8. An in-tank filter media reactor comprising:
a base coupled to a filter media container;
a top funnel component coupled to the top of the filter media container;
a bottom mesh filter element attached to the center area of the media container;
a top mesh filter element located between the funnel top and the bottom mesh filter element;
wherein the base includes a base opening sized to allow fluid to flow through the base opening, then up through the filter media container and eventually be drawn through the top funnel component when driven by a flow generated from a flow generator so as to produce a Venturi effect;
ballast located to hold the in-tank filter media reactor in place in an aquarium; and
wherein the filter media container is filled with a filter media selected from the group consisting of chemical filter media, activated carbon-based media, phosphate removers, bio-pellets, and combinations thereof.

9. The in-tank filter media reactor of claim 8 wherein the base and funnel are fabricated from plastic polymers, nylon polymers, acrylic polymers or combinations thereof.

10. The in-tank filter media reactor of claim 8 wherein the bottom mesh filter element comprises a mesh made from material selected from the group consisting of nylon, polymers, polyester and combinations thereof.

11. The in-tank filter media reactor of claim 8 wherein the flow generator comprises a power head affixed to a tank wall.

12. A method for filtering an aquarium comprising:
installing an in-tank filter media reactor including a base coupled to a filter media container with a top funnel component coupled to the top of the filter media container and a bottom mesh filter element attached to the center area of the media container wherein the base includes a base opening sized to allow fluid to flow through the base opening, then up through the filter media container and eventually be drawn through the top funnel component when driven by a flow generated from a flow generator so as to produce a Venturi effect;
filling the filter media container with a filter media selected from the group consisting of chemical filter media, activated carbon-based media, phosphate removers, bio-pellets, and combinations thereof;
securing the in-tank filter media reactor in place in an aquarium; and
generating a fluid flow into the opening so as to produce a Venturi effect that tumbles the filter media.

13. The method of claim 12 wherein the flow generator is a power head and generating a fluid flow comprises operating a power head within the tank.

14. The method of claim 12 wherein the bottom mesh filter element has openings of at least about 0.008 inches with a thickness of at least about 0.006 inches.

15. The in-tank filter media reactor of claim 1 wherein the bottom mesh filter element has openings of at least about 0.008 inches with a thickness of at least about 0.006 inches.

16. The in-tank filter media reactor of claim 8 wherein the bottom mesh filter element has openings of at least about 0.008 inches with a thickness of at least about 0.006 inches.
